(19) United States
(12) Patent Application Publication
(10) Pub. No.: US 2016/0275250 A1
(43) Pub. Date: Sep. 22, 2016

(54) DRUG FORMULARY DOCUMENT PARSING AND COMPARISON SYSTEM AND METHOD

(71) Applicant: BIOPOLICY INNOVATIONS INC., Vancouver (CA)

(72) Inventors: Andrew PARK, Blaine, WA (US); Drew GUTSCHMIDT, Vancouver (CA)

(21) Appl. No.: 15/072,702

(22) Filed: Mar. 17, 2016

Related U.S. Application Data
(60) Provisional application No. 62/134,266, filed on Mar. 17, 2015.

(51) Int. Cl. G06F 19/00; G06F 17/30

(52) U.S. Cl. CPC G06F 19/324; G06F 19/328; G06F 17/30675; G06F 17/30914

(57) ABSTRACT

A method of extracting data from a formulary document is provided, the formulary document in a non-text format, and the formulary document including a grouping of data, the method including: determining if the formulary document is different compared to a previously stored version of the formulary document; if the formulary document is different compared to the previously stored formulary document: converting the formulary document to a text based format while maintaining the data grouping; comparing the text based formulary document with a version of the previously stored formulary document in the text based format; and generating a report showing the differences between the formulary document and the previously stored formulary document.

### RELATED APPLICATIONS

This application claims the benefit of U.S. Provisional Patent Application No. 62/134,266 filed Mar. 17, 2015, which is hereby incorporated by reference in its entirety.

### FIELD OF THE INVENTION

The invention relates to the pharmaceutical, healthcare insurance, and healthcare insurance information processing industries, and more particularly to aggregating data for use in the health insurance and pharmaceutical industries.

### BACKGROUND

Drug companies, health insurance companies and healthcare providers, as a part of their business practices, track drug formulary documents released by health insurance companies. These drug formulary documents include the details of one or more drugs' coverage and reimbursement status as indicated by a drug's tier, which is the level of reimbursement of that drug to the patient, usually graded on a scale from 1 (fully reimbursed) to 7 (little to no reimbursement). Other information, such as prior approval requirements, specialty pharmacy requirements and other criteria is also found on the formulary documents. Currently, drug companies, health insurance companies and healthcare providers track changes to these drug formulary documents manually, by visually comparing one drug formulary document to its predecessor or successor, which is a very laborious task.

The visual inspection and documentation of differences in one version of a drug formulary document to another is an extremely laborious and error prone means of keeping track of changes to a formulary document. A single drug formulary document may have over 6000 drugs listed. There can be anywhere from a dozen to hundreds of formulary documents released by each health insurance company, and there are about 1000 companies that release these formulary documents. It is virtually impossible for this task to be completed manually with any degree of accuracy and efficiency.

Formulary documents are typically publicly available PDF files. There are methods of scanning PDF files for conversion into text documents or other formats in the prior art (for example U.S. Pat. No. 8,218,887 describes the use of OCR technology to convert PDF content to .txt files). However, such conventional means have difficulties when dealing with formulary documents, as formulary documents typically contain tables and other groupings of text which, when parsed, tend to lose these groupings and the meaning behind them.

### SUMMARY OF THE INVENTION

The system and method according to the invention address the issue of tracking changes to formulary documents released by health insurance companies by automating the tracking process using an online software system which can convert the formulary documents, including those in PDF format, into a plain text format while maintaining the relevant groupings of information, which are then converted to a database table and made accessible via an online user interface.

A method of determining changes in a formulary document in PDF format having a grouping of data therein is provided, including: accessing the formulary document; comparing the size of the formulary document to a previously accessed stored version of the formulary document (or alternatively using a checksum command to compare the documents, checking md5 tags of the documents, checking HTML tags of the documents or websites where the documents are made accessible, checking document XML metadata tags, querying the server hosting the document for its last modified date and/or converting the documents to text and then comparing); and if the size of the formulary document and the previously accessed stored formulary document are not equal then converting the formulary document to a text based format while maintaining the data grouping; comparing the text based formulary document with a text based version of the previously accessed stored formulary document; and generating a report showing the differences between the formulary document and the previously accessed stored formulary document.

A method of extracting data from a formulary document is provided, the formulary document in a non-text format, and the formulary document including a grouping of data, the method including: determining if the formulary document is different compared to a previously stored version of the formulary document; if the formulary document is different compared to the previously stored formulary document: converting the formulary document to a text based format while maintaining the data grouping; comparing the text based formulary document with a version of the previously stored formulary document in the text based format; and generating a report showing the differences between the formulary document and the previously stored formulary document.

The method may include replacing the previously stored formulary document with the formulary document. The method may include, when converting the formulary document to a text based format, parsing the formulary document. The parsing may include extracting text, text styling and text positioning information to determine one or more blocks of text. Tables may be detected in the formulary document and one or more columns may be determined in the formulary document. Each of the one or more blocks may be placed within a column selected from the one or more columns. The type of data in each column may be determined. At least one of the types of data is a restriction criteria associated with a drug listed in the formulary document.

The formulary document may be in a PDF format. The determination if the formulary document is different compared to the previously stored formulary document may include comparing the size of the formulary document to the previously stored version of the formulary document; using a checksum command; comparing md5 tags; comparing HTML tags of the formulary document and the previously stored formulary document or the website from where the formulary document was accessible to a previously stored version of the website from which the previously stored version of the formulary document was accessible; comparing XML metadata tags; and/or querying a server hosting the formulary document for a last modified date.

The method may be implemented by a server configured to carry out the steps of the method, including accessing the formulary document; determining if the formulary document is different compared to a previously stored version of the formulary document; if the formulary document is not the same as the previously stored version of the formulary document: convert the formulary document to a text based format while maintaining the data grouping; compare the text based formulary document with a text based version of the previously stored formulary document; and generate a report showing the differences between the formulary document and the previously stored formulary document.

The server may be further configured to replace the previously stored formulary document with the formulary document and to parse the formulary document, the parse including extracting text, text styling and text positioning information to determine one or more blocks of text.

The server may be further configured to detect tables in the formulary document using sets of heuristics; to determine one or more columns in the formulary document; to place each of the one or more blocks within a column selected from the one or more columns; and to determine the type of data in each of the one or more columns.

### DESCRIPTION OF THE FIGURES

FIG. 1 is an embodiment of a system according to the invention.

FIG. 2 is an example of a representation of a portion of a drug formulary document in a PDF format.

FIG. 3 is an alternative example of representation of a portion of a drug formulary document in a PDF format.

FIG. 4 is yet another alternative example of a representation of a portion of a drug formulary document in a PDF format.

FIG. 5 is a flow chart showing an embodiment of a conversion process of the drug formulary document according to the invention.

FIG. 6 is a representation of a portion of an embodiment of a database after the parsing process has been completed.

FIG. 7 is a flow chart showing an embodiment of the process by which formulary documents are selected for conversion and a difference report generated.

FIG. 8 is a representation of a portion of an embodiment of a difference report generated by the system after the system detects a new version of the formulary document and compares it to the previous version.

FIG. 9 is a representation of how various tables of differing formats with marker columns are converted to uniform, conventional tables according to the invention.

FIG. 10 is a representation of two sample pages of formulary documents illustrating various characteristic text layouts and classes, the patterns of which are recognized by the system according to the invention as the document is parsed according to patterns detected by the system and the text within the page sections are then insertable into uniform, conventional tables

### DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or system elements described in the present application constitutes the invention claimed herein, or is essential to the invention claimed herein, or is coextensive with the invention claimed herein, except where it is either expressly stated to be so in this specification or expressly recited in a claim.

The system and method according to the invention tracks changes to formulary documents in a PDF and other formats that are released by health insurance companies by automating the tracking process using an online software system which converts the formulary documents into a plain text format while keeping the relevant groupings of information in the document which are then converted to a database format and made accessible via an online user interface.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention, or components thereof, can be practiced with other computing system configurations, including hand-held devices, multiprocessor systems, microprocessor-based or programmable consumer electronics, personal computers (“PCs”), network PCs, mini-computers, mainframe computers, mobile phones, smart phones, tablets, personal digital assistants, personal music players (like iPods) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other devices involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, flash drive, and an optical disk drive; and a magnetic disk drive for reading from and writing to removable optical disks and magnetic disks, respectively. The optical disk can be a CD-ROM or BLU-RAY, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla, Google and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known, including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter. The computing system can include other output devices, such as speakers, printers, etc.

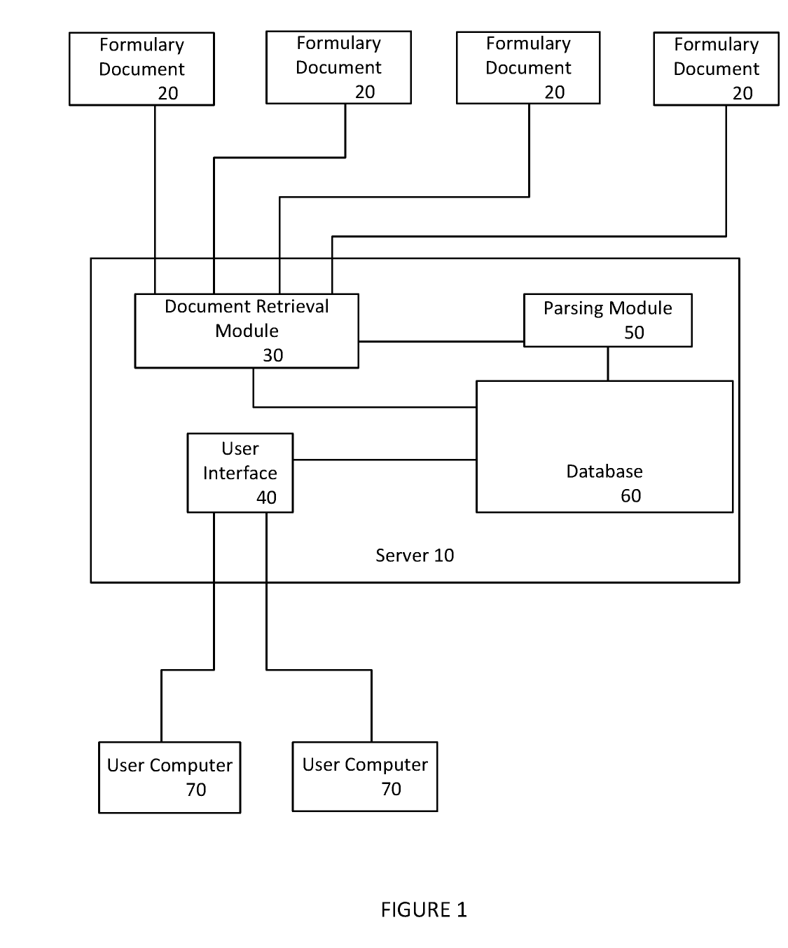

FIG. 1 shows an embodiment of the system according to the invention. Drug formulary documents 20 are available on computer systems accessible via a network such as the Internet. Server 10, through document retrieval module 30 can access and download drug formulary documents 20 as described herein. Parsing module 50 is used to parse downloaded drug formulary documents 20 and the drug formulary documents 20 and the parsed versions thereof, are stored in database 60. User interface 40 allows user computers 70 to access database 60, and view the parsed or original drug formulary documents.

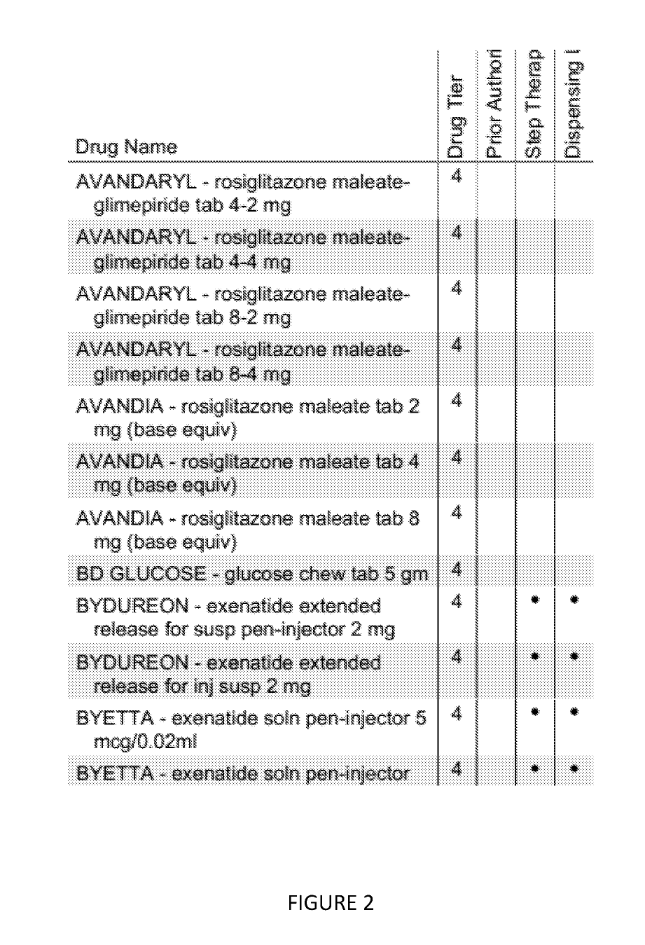

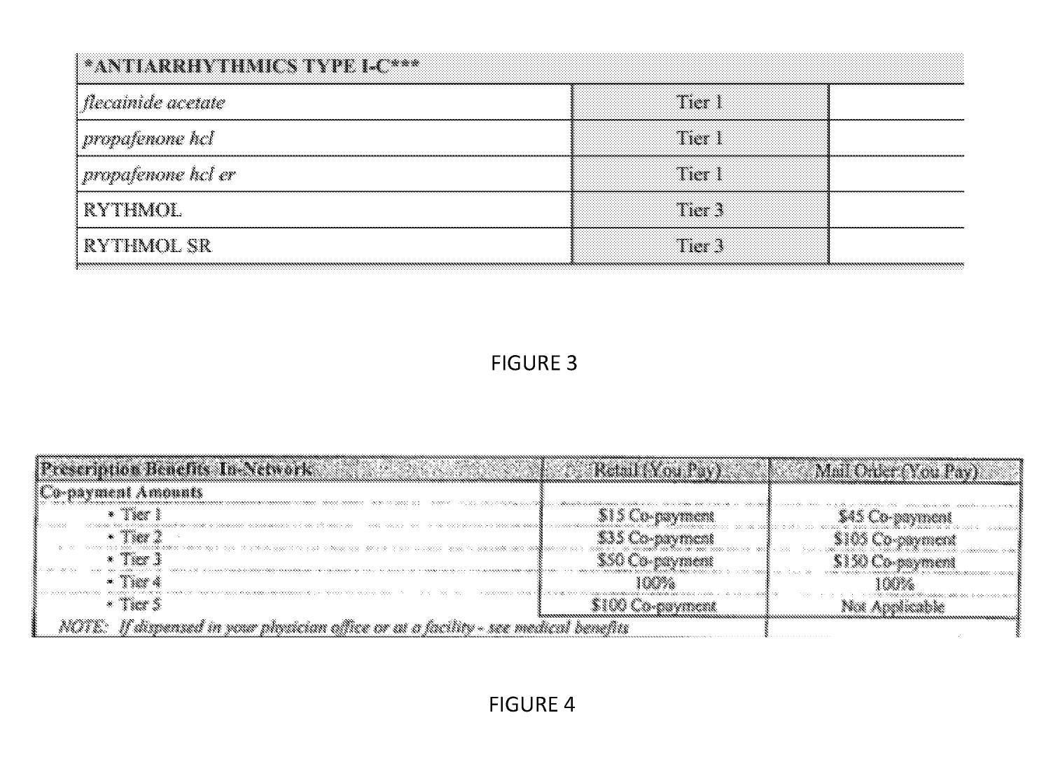

Typical representations of portions of drug formulary documents 20 are shown in FIGS. 2, 3 and 4. The formulary documents 20 are usually available in a PDF format, but may also be in a WORD document format, .xls format, HTML format, RSS format, PPT format or in an image format, such as a GIF or JPG (these formats are referred to herein as “non-text formats”). The information in the formulary documents 20 is typically represented in tables, often with indicators such as the dots shown in FIG. 2, rather than text. As noted, each of the formulary documents 20 shown in FIGS. 2, 3 and 4 displays the information related to a particular drug in a different format.

Server 10, through document retrieval module 30, accesses the drug formulary documents 20 via the Internet or another network for parsing by a parsing module 50 running a script. Unlike other file types, such as HTML or XML (both of which are plaintext-encoded), PDF files are binary-encoded. This means that the information contained in the PDF files is not immediately legible to humans but must be decoded using various software algorithms

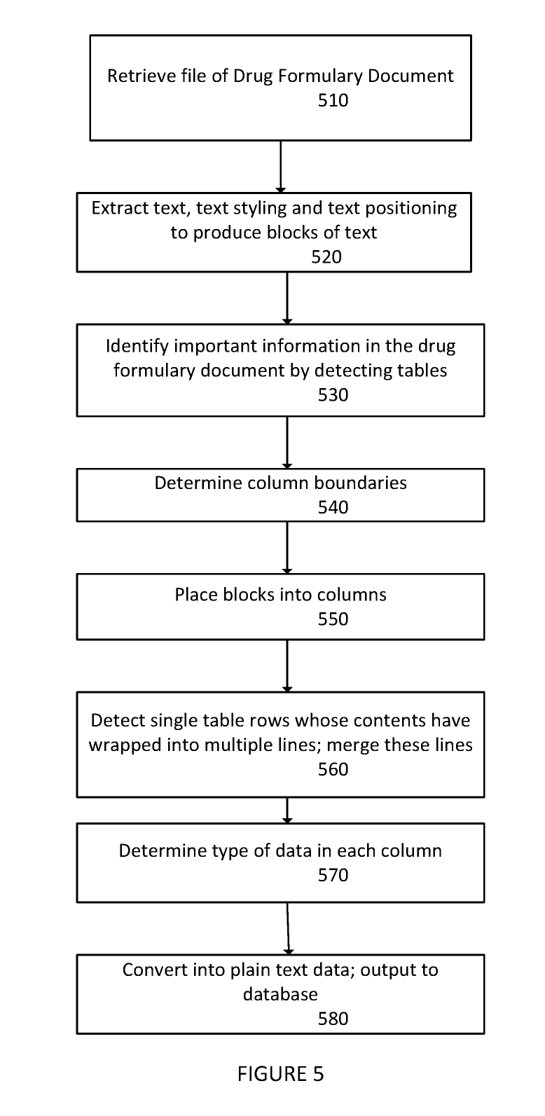

As shown in FIG. 5, after retrieval of the drug formulary documents in a PDF or image format (step 510), parsing module 50 parses formulary documents 20 using a script to generate files with formats such as TXT, RTF, CSV, SQL or a different raw data file using a combination of text recognition, embedded PDF table recognition, data grouping recognition and optical character recognition (OCR). The script also recognizes data and information groupings and maintains those groupings in the data output. This is accomplished in multiple stages. First the scripts decode the PDF documents from binary format and extract the text, text styling (font size, font weight, etc.) and text positioning coordinates from each PDF. The results of this parsing produce a list of blocks of text (step 520). On average, each PDF page may produce approximately 100 blocks, and, depending on the character spacing, line spacing and layout of the original PDF, each block may contain a letter, a word, a table cell, a line of text, or an entire paragraph. Each text block is also accompanied by metadata which describes its font style, position, width and height. This metadata leaves a statistical signature embedded in the position and dimensions of text blocks.

A programmed lexicon is used to identify important information in the formulary document. Specifically, the drug/tier/dosage/coverage restriction information and criteria is often contained in tables. By identifying which parts of a PDF document represent tables and which columns in those tables represent which classes of information, the relevant data can be extracted and labeled (step 530).

To detect tables the method according to the invention uses the premise that tables are often signaled by the repeated presence of many blocks of text on the same line as well as by the repeated presence of many blocks of text whose left, right or center x-coordinates align. Each line of text is then slotted into different “classes” depending on how many text blocks the line contains and on the x-coordinates of those blocks. A statistical analysis on these classes takes into account their frequency, y-coordinates, average separation, etc. to determine which classes may represent table rows. A set of heuristics is also used to identify tables, such as text matching to identify content that should be contained within a table, and identifying content that should not be contained within a table.

The next step is to analyze each table and line individually in order to determine column boundaries (step 540). A variety of statistical and heuristic methods may be used to identify actual columns and false positives.

Once the columns are determined, the blocks on each line in the table are slotted into these columns (step 550), taking into account that every line may have a larger or smaller number of blocks than the number of columns found. Then another statistical and heuristic analysis is performed to detect consecutive lines which appear to represent single table rows in cases where the contents have wrapped onto multiple lines. These lines are then merged together (step 560).

The text content of each column in each table is then analyzed and characterized in order to determine what type of data it may represent (step 570). Alternative column data formats are shown in FIG. 9. Column data may be represented by text or symbols. Once the raw data is entered into database 60 (step 580), it can be recombined in a variety of formats using a variety of SQL queries. These queries can be used to present the data to database administrators for editing or annotation purposes or to a search engine for indexing. The queries can also be used to display the data to users through user interface 40 via web pages or generated reports.

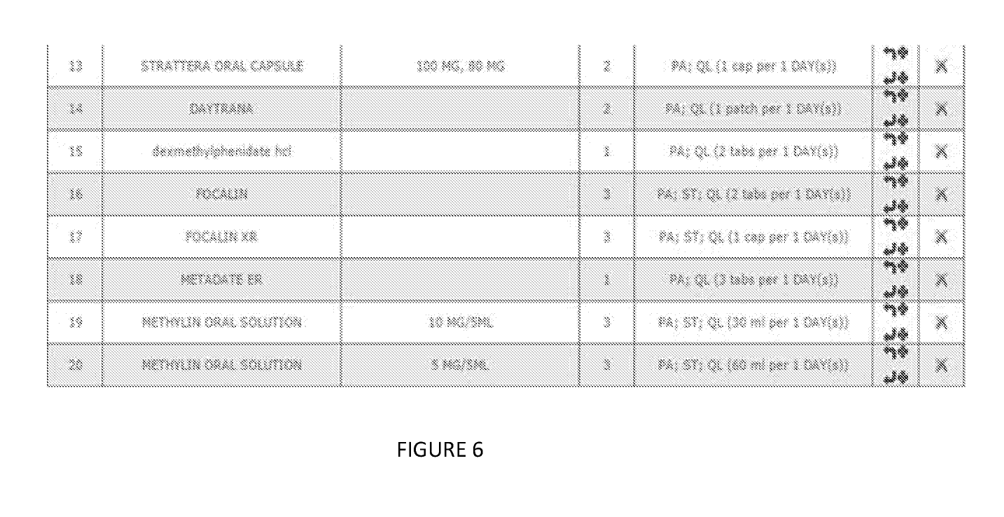

The plain text data output can then be imported into a SQL table as shown in FIG. 6 (although other database formats could be used), where the data can be accessed through an user interface 40 accessing server 10 from a user computer 70. Using the user interface 40, a user can access and organize information by insurance company, insurance plan, region, drug name, drug class, drug indication, reimbursement rate, restriction criteria and/or other criteria. Restriction criteria are conditions that insurance companies put in their formulary documents to further define how well a drug is covered. Some examples of restriction criteria are: quantity limit (the maximum times a prescription of a drug will be approved); prior authorization (a form must be submitted for the insurance company to pre-approve a prescription for a drug); and step therapy (another drug, usually a generic form, must be tried before the drug will be approved).

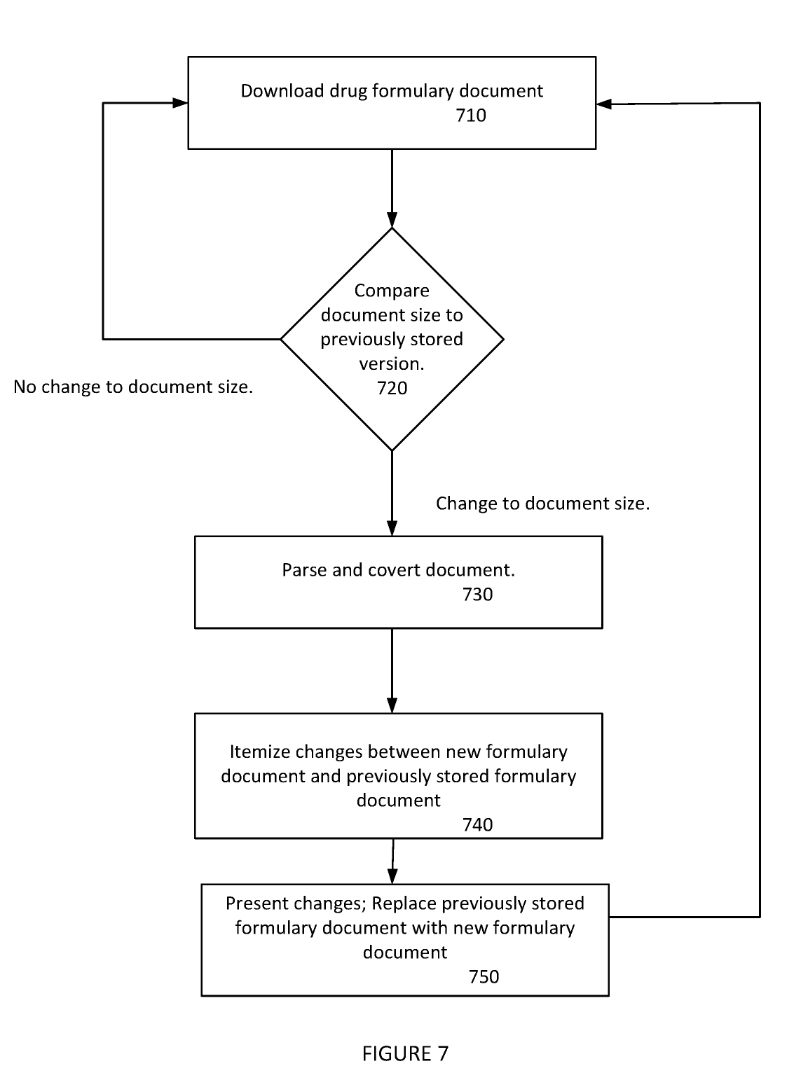

As shown in FIG. 7, the system tracks when a new formulary document 20 is released by document retrieval module 30 downloading each formulary document (step 710) at regular intervals, such as nightly (although other time frames may be used such as twice a day, weekly, or every two days) and comparing the document size to the previous corresponding formulary document stored in the system (step 720). Alternatively the system can use one or more alternate means in addition to or instead of comparing document size to compare the formulary document with the previously stored formulary document, including using a checksum command to compare the documents, comparing MD5 tags of the documents, comparing HTML tags of the documents or websites where the document are available, comparing document XML metadata tags, querying the server hosting the document for its last modified date and/or converting the documents to text and then comparing. If the document 20 size has changed or any other indication of a change of the formulary document is returned, the system parses the new document and coverts it into plain text, rich text, .csv, .sql and/or other raw document or database formats as described above (step 730). If the document 20 is still the same size as the previously stored document, or other indicators return a negative result for change of document 20, the system will download a new document for comparison after a period of time has elapsed.

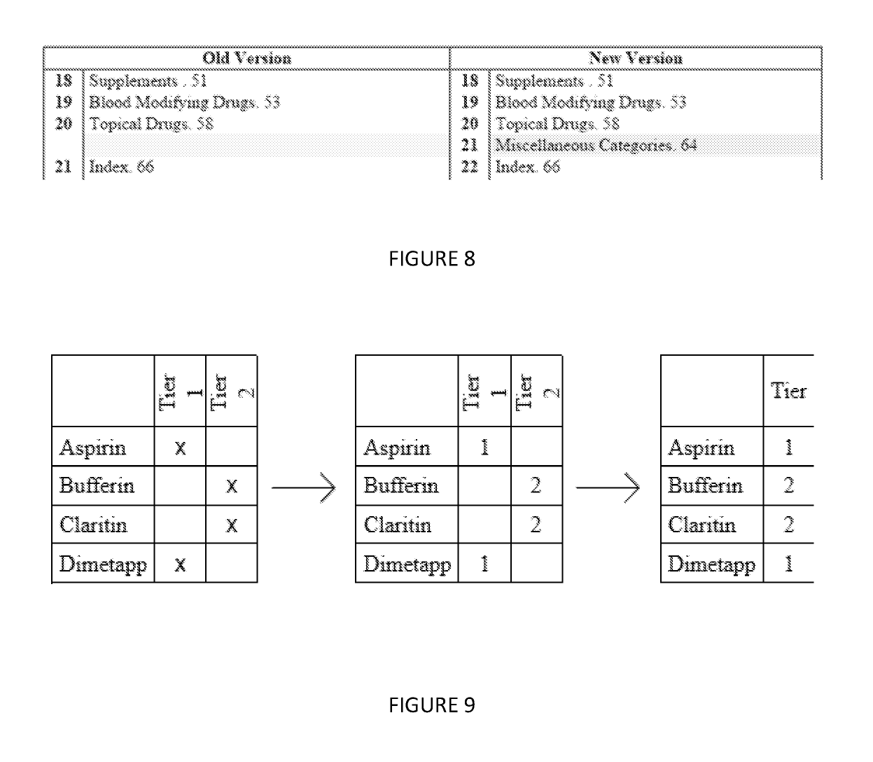

The new plain text and old plain text documents are then compared and the system itemizes changes between the two documents (step 740) and outputs the changes in a difference report, a portion of an embodiment of which is shown in FIG. 8. The previously stored formulary document is then replaced with the new formulary document 20 for the purpose of future comparisons with downloaded documents. Document changes and difference reports are accessible via user interface 40 that is configured to display the data in a user friendly manner.

The previously stored and converted formulary document can serve as a baseline with respect to table formatting and the like for future versions of the formulary document. However should there not be a previously stored version of the formulary document, then a baseline can be created and the formatting details of the formulary document stored for use with future versions of the formulary document.

FIG. 9 shows an embodiment of the conversion of raw text differences detected (such as those shown in FIG. 8) into a pre-designed table that notates the drug name and other key drug insurance information related to the problem domain. FIG. 9 shows the consolidation of varying structures of tables of disparate documents into a pre-designed table that displays the data in a uniform format.

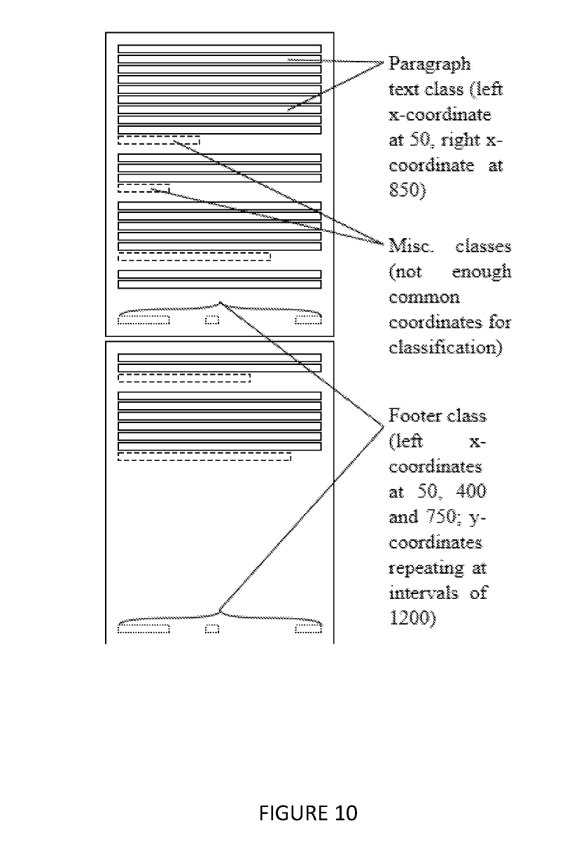

FIG. 10 illustrates an embodiment of the method by which the raw text is converted to discernable data appropriate for table inclusion. The system parses the newly detected formulary document 20 based on pattern recognition rules and parses the text within these patterns to input the pertinent data into the aforementioned, pre-designed table.

The server 10 may send automated email alert notifications to subscribers notifying them of specific changes to a particular formulary document, so the subscribers can adjust their business strategies accordingly.

The system and method according to the invention allows health insurance companies to track competitor's formulary documents to ensure their health plans are competitive and cost effective. Pharmaceutical companies can use the system and method according to the invention to track insurance coverage of their drugs, competing drugs and complementary drugs. Pharmaceutical companies can use the system and method track the level of reimbursement a drug is receiving per formulary, and per insurance company. This allows the company to target sales and marketing efforts to ensure their drug is favorably covered and to target the appropriate patient base. Healthcare providers can use the system and method to help choose the drugs they administer/prescribe based on a patient's access and ability to pay for those drugs, and consult with patients regarding the patient's coverage and access to medications. Patients can use the system to view information on the drugs they are prescribed to view whether their plan covers the drugs and the level of reimbursement the insurance company provides.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments, or portions thereof, of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a computer program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

1. A method of extracting data from a formulary document, the formulary document in a non-text format, and the formulary document comprising a grouping of data, the method comprising:
a. determining if the formulary document is different compared to a previously stored version of the formulary document;
b. if the formulary document is different compared to the previously stored formulary document:
i. converting the formulary document to a text based format while maintaining the data grouping;
ii. comparing the text based formulary document with a version of the previously stored formulary document in the text based format; and
iii. generating a report showing the differences between the formulary document and the previously stored formulary document.

2. The method of claim 1 further comprising replacing the previously stored formulary document with the formulary document.

3. The method of claim 1 wherein the converting the formulary document to a text based format comprises parsing the formulary document.

4. The method of claim 3 wherein the parsing extracts text, text styling and text positioning information to determine one or more blocks of text.

5. The method of claim 4 wherein tables are detected in the formulary document.

6. The method of claim 5 wherein one or more columns are determined in the formulary document.

7. The method of claim 6 wherein each of the one or more blocks is placed within a column selected from the one or more columns.

8. The method of claim 7 wherein the type of data in each column is determined.

9. The method of claim 8 wherein at least one of the types of data is a restriction criteria associated with a drug listed in the formulary document.

10. The method of claim 1 wherein the formulary document is in a PDF format.

11. The method of claim 1 wherein determining if the formulary document is different compared to the previously stored formulary document comprises comparing the size of the formulary document to the previously stored version of the formulary document.

12. The method of claim 1 wherein determining if the formulary document is different compared to the previously stored formulary document comprises using a checksum command.

13. The method of claim 1 wherein determining if the formulary document is different compared to the previously stored formulary document comprises comparing md5 tags.

14. The method of claim 1 wherein determining if the formulary document is different compared to the previously stored formulary document comprises comparing HTML tags of the formulary document and the previously stored formulary document or the website from where the formulary document was accessible to a previously stored version of the website from which the previously stored version of the formulary document was accessible.

15. The method of claim 1 wherein determining if the formulary document is different compared to the previously stored formulary document comprises comparing XML metadata tags.

16. The method of claim 1 wherein determining if the formulary document is different compared to the previously stored formulary document comprises querying a server hosting the formulary document for a last modified date.

17. A system for determining changes in a formulary document in a non-text format having a grouping of data therein, comprising:
a. a server configured to:
i. access the formulary document;
ii. determining if the formulary document is different compared to a previously stored version of the formulary document;
iii. if the formulary document is not the same as the previously stored version of the formulary document:
a) convert the formulary document to a text based format while maintaining the data grouping;
b) compare the text based formulary document with a text based version of the previously stored formulary document;
c) generate a report showing the differences between the formulary document and the previously stored formulary document.

18. The system of claim 17 wherein the server is further configured to replace the previously stored formulary document with the formulary document.

19. The system of claim 18 wherein the server is further configured to parse the formulary document.

20. The system of claim 19 wherein the parse extracts text, text styling and text positioning information to determine one or more blocks of text.

21. The system of claim 20 wherein the server is further configured to detect tables in the formulary document using sets of heuristics.

22. The system of claim 21 wherein the server is further configured to determine one or more columns in the formulary document.

23. The system of claim 22 wherein the server is further configured to place each of the one or more blocks within a column selected from the one or more columns.

24. The system of claim 23 wherein the server is further configured to determine the type of data in each of the one or more columns.

25. The system of claim 24 wherein at least one of the types of data is a tier associated with a drug listed in the formulary document.

26. The system of claim 17 wherein the formulary document is in a PDF format.

27. The system of claim 17 wherein determining if the formulary document is different compared to the previously stored version of the formulary comprises one or more of the following:
a. comparing the size of the formulary document to a previously stored version of the formulary document;
b. using a checksum command to compare the formulary document to the previously stored version of the formulary document,
c. comparing md5 tags of the formulary document and the previously stored version of the formulary document
d. comparing HTML tags of the formulary document and the previously stored version of the formulary document;
e. comparing HTML tags of the website from where the formulary document was accessible to a previously stored version of the website from which the previously stored version of the formulary document was accessible;
f. comparing the XML metadata tags of the formulary document and the previously stored formulary document; and
g. querying a server hosting the formulary document for a last modified date of the formulary document.
